(19) United States
(12) Patent Application Publication
(10) Pub. No.: US 2006/0176034 A1
(43) Pub. Date: Aug. 10, 2006

(54) Multi-resonant dc-dc converter

(76) Inventor: Andrew John Skinner, Devon (GB)

Correspondence Address: MYERS BIGEL SIBLEY & SAJOVEC, PO BOX 37428, RALEIGH, NC, 27627, US

(21) Appl. No.: 10/528,717

(22) PCT Filed: Sep. 18, 2003
(86) PCT No.: PCT/GB03/04030

§ 371 Date: Mar. 18, 2005

(30) Foreign Application Priority Data
Sep. 20, 2002 (GB) 0221836.0

(51) Int. Cl. G05F 1/40; G05F 1/618

(52) U.S. Cl. 323/282

(57) ABSTRACT

A power converter apparatus include a multi-resonant circuit comprising a series-resonant circuit and a frequency-dependent impedance connected in series with the series-resonant circuit and operative to counteract an inductance of the series-resonant circuit, a switching circuit operative to alternately apply first and second voltages to an input of the multi-resonant circuit, and a rectifier circuit, coupled to an output of the multi-resonant circuit. The invention also provides power conversion methods.

The present invention relates to power conversion apparatus and methods, and more particularly, to resonant converters and methods.

Resonant and quasi-resonant converters have been proposed for a variety of power conversion applications, such as in highly integrated, high frequency DC-DC converters. Using resonance between capacitances and inductances, some resonant converters can be configured to provide zero current switching (ZCS) and/or zero voltage switching (ZVS) to reduce switching losses and/or electromagnetic interference. However, some conventional resonant converter designs may exhibit excessive current and/or voltage stress on switching elements. Special control and/or protection schemes that reduce such stress may lead to low efficiency and unwanted complexity.

A combined current and voltage resonant converter that addresses some of the aforesaid problems is proposed in “The Current Resonant Converter, Theory and Implementation,” by Asou et a1., PCIM '95, Nurnberg. In particular, the converter described in this article uses leakage inductance of a resonant transformer as a resonant inductance in a series resonant circuit, and utilizes power switch capacitance for reduced loss snubbing. A potential shortcoming of such a series resonant converter, however, is that it may exhibit significant output current “dead time” and, consequently, undesirably high current ripple. In addition, operation of some series resonant converters below the resonant frequency of the series resonant circuit may be destructive to the switching elements, as the switching elements may operate with capacitive loading that leads to high switching losses. Because of this latter issue, some conventional series resonant converters may need to be designed to have a minimum operating frequency that is well above the resonant frequency, which can lead to high circulating currents and undesirably low efficiency operation.

According to one aspect of the invention, a power converter apparatus, such as a DC-DC converter, includes a multi-resonant circuit comprising a series-resonant circuit and a frequency-dependent impedance connected in series with the series-resonant circuit and operative to counteract an inductance of the series-resonant circuit, a switching circuit operative to alternately apply first and second voltages to an input of the multi-resonant circuit, and a rectifier circuit coupled to an output of the multi-resonant circuit.

The switching circuit may be a half-bridge operable to apply alternately first and second voltages to the input of the multi-resonant circuit.

The frequency-dependent impedance may decrease with an increase in frequency at which the first and second voltages are applied to the multi-resonant circuit.

According to another aspect of the invention a power converter apparatus, comprises:

a multi-resonant circuit comprising cascaded first and second series-resonant stages having respective first and second resonant frequencies;

a switching circuit operative to alternately apply first and second voltages to an input of the multi-resonant circuit; and

a rectifier circuit coupled to an output of the multi-resonant circuit.

According to another aspect the invention provides a power conversion method comprising alternatively applying first and second voltages to an input of a multi-resonant circuit comprising a series-resonant circuit and a frequency-dependant impedance connected in series with the series-resonant circuit and operative to counteract an inductance of the series-resonant circuit; and responsively generating a DC voltage from a voltage at the output of the multi-resonant.

According to yet another aspect the invention provides a power conversion method, comprising:

alternately applying first and second voltages to an input of a multi-resonant circuit comprising cascaded first and second series-resonant stages having respective first and second resonant frequencies; and

responsively generating a DC voltage from a voltage at the output of the multi-resonant circuit.

In further embodiments of the invention, the first resonant frequency is less that the second resonant frequency. The first series-resonant stage may be configured to allow the second series-resonant stage to operate at the second resonant frequency while maintaining inductive loading of the switching circuit. In particular, the apparatus may include a clamping circuit coupled to the multi resonant circuit and operative to limit a voltage at the output of the multi-resonant circuit and limit capacitive loading of the switching circuit by the second series-resonant stage.

In some embodiments, the first and second resonant stages include respective series combinations of a capacitor and an inductor. For example, the inductors of the first and second series-resonant stages may include an inductance of a transformer, and the rectifier circuit may be coupled to a secondary winding of the transformer.

In further embodiments, the switching circuit is operative to alternately couple first and second terminals of a DC power source to an input of the multi-resonant circuit. The multi-resonant circuit includes a first capacitor having a first terminal coupled to the switching circuit, an inductor having a first terminal coupled to a second terminal of the first capacitor, and a second capacitor having a first terminal coupled to a second terminal of the inductor and a second terminal configured to be coupled to one of the first and second terminals of the DC power source.

In additional embodiments of the invention, the multi-resonant circuit includes a series combination of a first capacitor, first and second primary windings of respective first and second transformers, and a second capacitor. The rectifier circuit includes a self-driven synchronous rectifier circuit coupled to first and second secondary windings of the first and second transformers.

According to additional embodiments of the invention, a power converter apparatus includes a multi-resonant circuit including cascaded first and second series-resonant stages having respective first and second resonant frequencies. The apparatus further includes means, coupled to an input of the multi-resonant circuit, for alternately applying first and second voltages to the input of the multi-resonant circuit, and means, coupled to an output of the multi-resonant circuit, for generating a DC voltage from a voltage at the output of the multi-resonant circuit.

Embodiments of the invention can provide several advantages over conventional series-resonant converters and conversion methods. For example, converters according to some embodiments of the invention can operate at frequencies well below a desired minimum operating frequency while maintaining inductive loading on the converter's input stage to reduce switching losses. Converters according to embodiments of the invention can be designed to provide sufficient current at a designated minimum operating supply voltage to provide a desired output power, while providing safe operation in a resonant charge transfer mode at lower voltages and/or operating frequencies.

Embodiments of the present invention will now be described, by way of example only, with reference to the accompanying drawings wherein:—

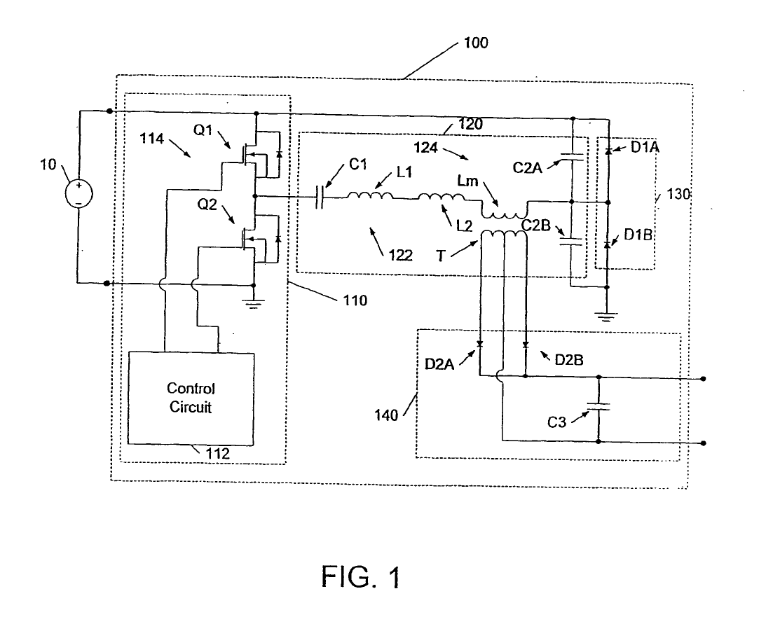

FIG. 1 is a schematic diagram of a power conversion apparatus according to some embodiments of the invention.

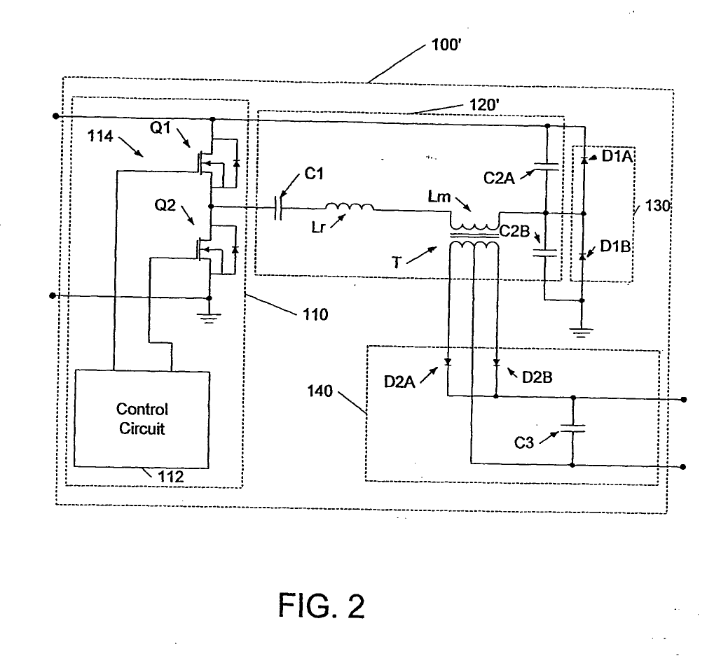

FIG. 2 is a schematic diagram of a power conversion apparatus according to further embodiments of the invention.

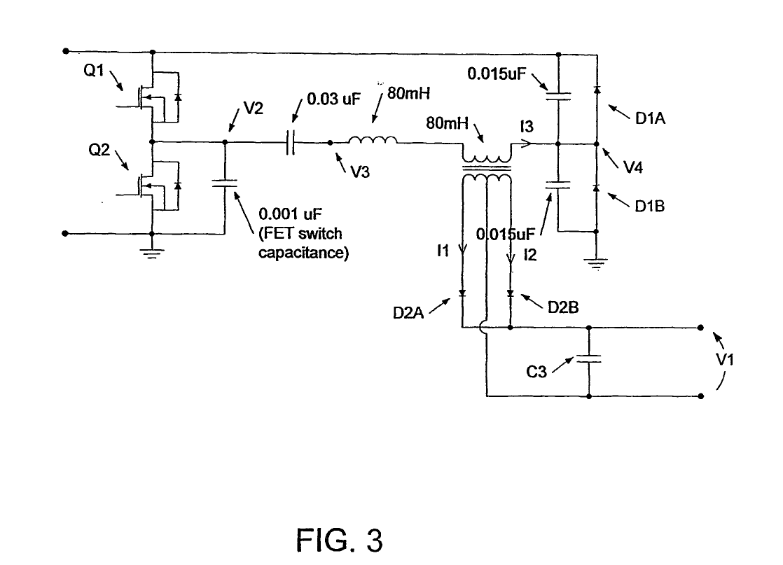

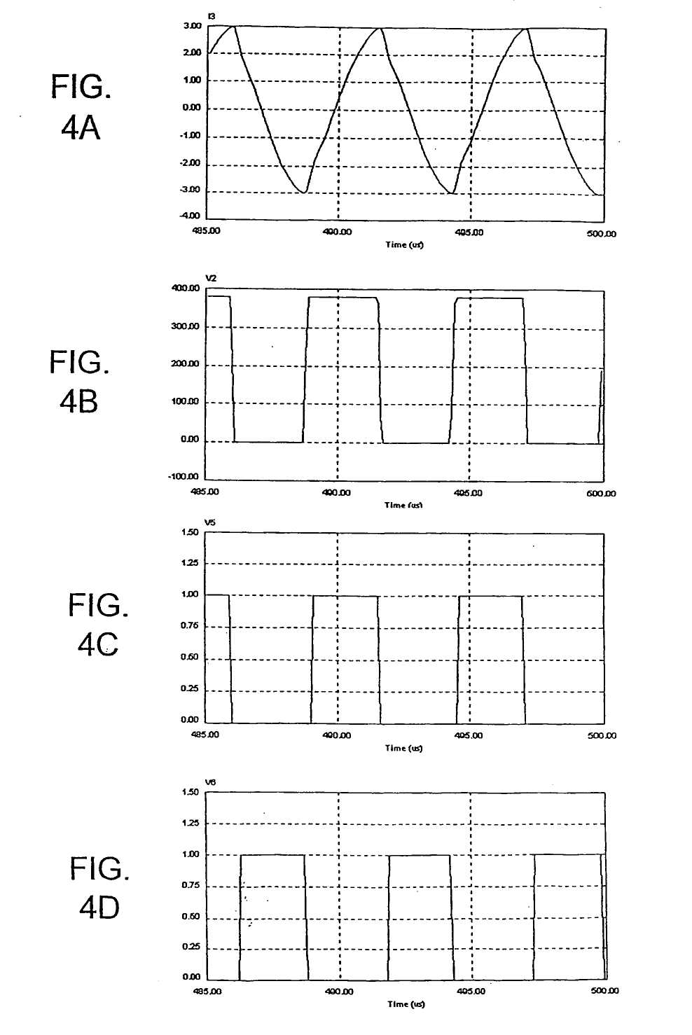

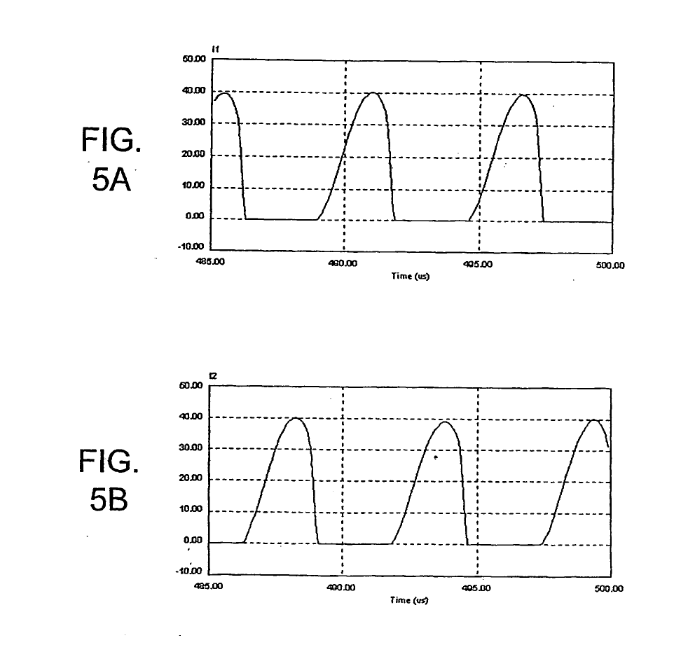

FIG. 3 is a schematic diagram of a power conversion apparatus according to additional embodiments of the invention.

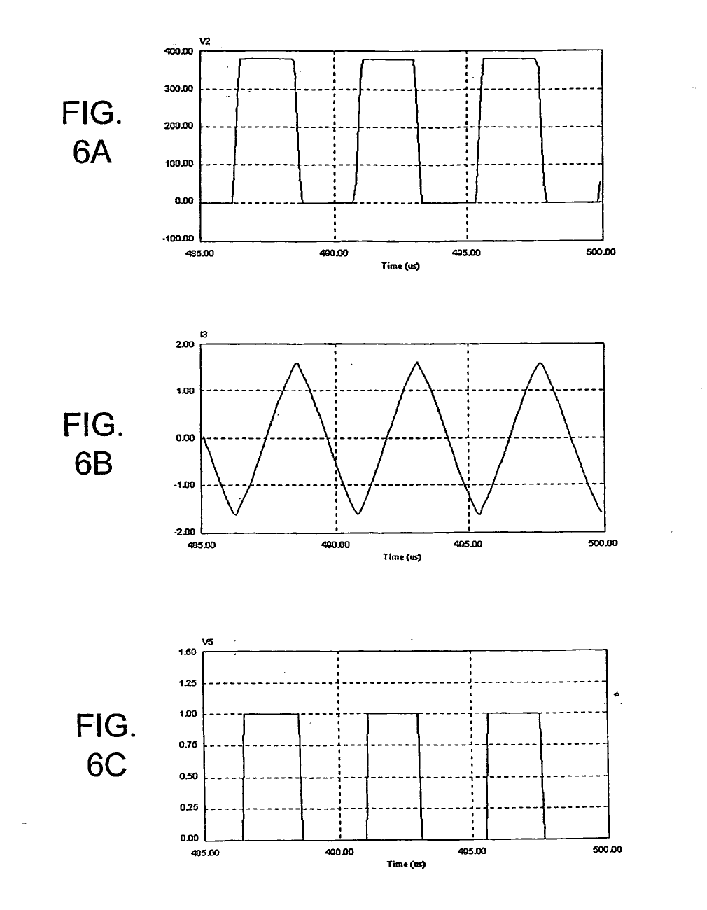

FIGS. 4-9 are waveform diagrams illustrating simulated operations of the power conversion apparatus of FIG. 3.

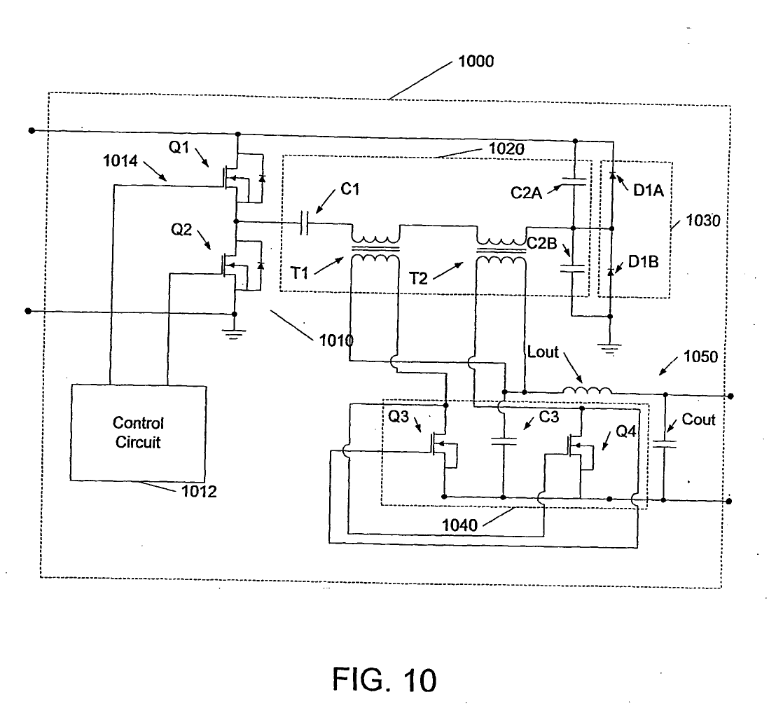

FIG. 10 is a schematic diagram of a power conversion apparatus according to further embodiments of the invention.

The present invention will now be described more fully with reference to the accompanying drawings, in which exemplary embodiments of the invention are shown. These embodiments are provided so that this application will be thorough and complete. In the drawings, like numbers refer to like elements. It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

FIG. 1 is a schematic illustration of a power conversion apparatus 100 according to some embodiments of the present invention. The apparatus 100 includes means, here shown as a half-bridge switching circuit 110, for alternately applying first and second voltages to an input of a multi-resonant circuit 120. The apparatus 100 also includes means, here shown as a rectifier circuit 140 including diodes D2A, D2B and a storage capacitor C3, for generating a DC voltage from an output of the multi-resonant circuit 120. The apparatus 100 further includes means, here shown as a clamping circuit 130 including diodes D1A, D1B, for limiting a voltage produced by the multi-resonant circuit 120.

In the illustrated embodiments of FIG. 1, the switching circuit 110 includes a half-bridge circuit 114 with first and second MOSFET transistors Q1, Q2 controlled by a control circuit 112. The control circuit 112 operates the transistors Q1, Q2 in a substantially complementary fashion such that first and second terminals of a DC power source 10 are alternately applied to the input of the multi-resonant circuit 120. It will be appreciated that circuitry other than a half-bridge configuration may be used to provide substantially similar functionality within the scope of the present invention. It will be further appreciated that circuits other than the illustrated rectifier circuit 140, such as synchronous rectifier circuits, may be used to provide substantially similar functionality within the scope of the present invention.

In FIG. 1, the multi-resonant circuit 120 is illustrated as including a series combination of a capacitor C₁, first and second inductors L1, L2, a magnetizing inductance Lm of a transformer T and capacitors C2A, C2B. In particular, this illustration represents a lumped parameter model that provides one of many possible ways of viewing the invention. In particular, as shown in FIG. 1, the multi-resonant circuit 120 may be viewed as including a first series resonant stage 122, including the capacitor C1 and the inductor L1, coupled in series with a second series resonant stage 124, including the inductor L2 and the capacitors C2A, C2B.

According to some embodiments of the invention, the first series resonant stage 122 has a resonant frequency that is lower than the resonant frequency of the second series resonant stage 124. In some embodiments, this can allow the second stage 124 to be operated down to its resonant frequency while maintaining inductive loading of the switching circuit 110 and providing zero-voltage switching for the transistors Q1, Q2.

The first stage 122 provides source impedance to the second stage 124. At high frequencies, C1 provides low impedance such that the sum of the inductors L1, L2 predominantly regulates the output voltage using the capacitors C2A, C2B as a resonating capacitance and the magnetizing inductance Lm as a shunt inductance. No-load operation is possible by allowing the voltage produced by the divider formed by the magnetizing inductance Lm and the sum of the inductors L1, L2 to be lower than the voltage needed to produce the desired output voltage. In short-circuit conditions, the apparatus 100 can be operated at a frequency significantly higher than the resonant frequency of the combination of the inductors L1, L2 and the capacitors C2A, C2B to control output current.

The clamping circuit 130 clamps the second stage 124, which can limit short circuit current and to allow the apparatus 100 to change to a resonant charge-transfer mode when operating near or below the resonant frequency of the second stage 124. This can restrict the secondary voltage that is developed on the transformer T such that the second stage 124 is prevented from presenting a capacitive load. To a first approximation, the clamping of the voltage across the capacitors C2A, C2B also effectively limits voltage across the capacitor C1.

It will be understood that the circuit topology illustrated in FIG. 1 can be implemented in a number of different ways. For example, FIG. 2 illustrates a practical implementation of a power conversion apparatus 100′ according to further embodiments of the invention. The apparatus 100′ includes an input switching circuit 110, a clamping circuit 130 and an output rectifier circuit 140 as described above. The apparatus 100′ further includes a multi-resonant circuit 120′ comprising capacitors C1, C2A, C2B and a series combination of an inductance Lr and a magnetizing inductance Lm of a transformer T. The inductance Lr may include a leakage inductance of the transformer T plus one or more external inductors.

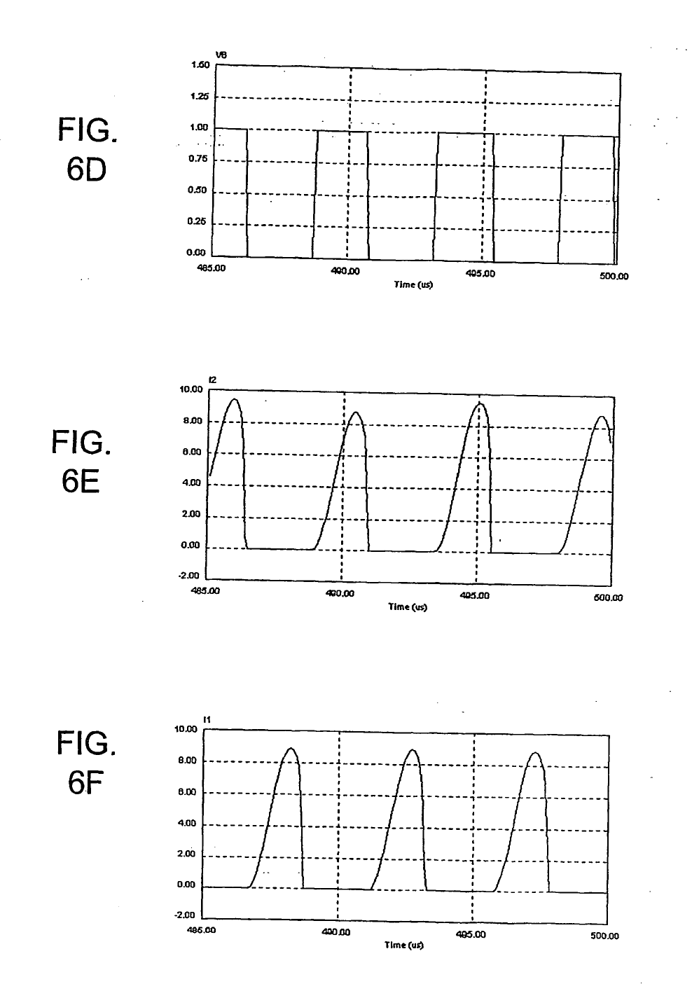

FIGS. 4-9 illustrate exemplary operations of the apparatus 100′ of FIG. 2 using the exemplary component values indicated in FIG. 3 (including a capacitance of the switching circuit 110 modeled as a discrete capacitor Cs) under a variety of different operating conditions. FIGS. 4A-4D are waveform diagrams of simulation results showing relationships among the drive signals V5, V6 applied to the transistors Q1, Q2, the output voltage V2 provided by the switching circuit 210, and current 13 through the primary of the transformer T at approximately 180 KHz. FIG. 5 shows output currents produced by the rectifier circuit 240, and currents 11, 12 in the diodes D2A, D2B of the rectifier circuit 240. As can be seen in FIGS. 5A-5B, which are for the same conditions as FIGS. 4A-4D, the currents 11, 12 fall and rise in a substantially complementary fashion with a relatively low or nonexistent “dead time” between fall of one of the currents 11, 12 and rise of the other of the currents 11, 12, such that, under the simulated conditions, the output current ripple produced by the output rectifier circuit can be relatively low.

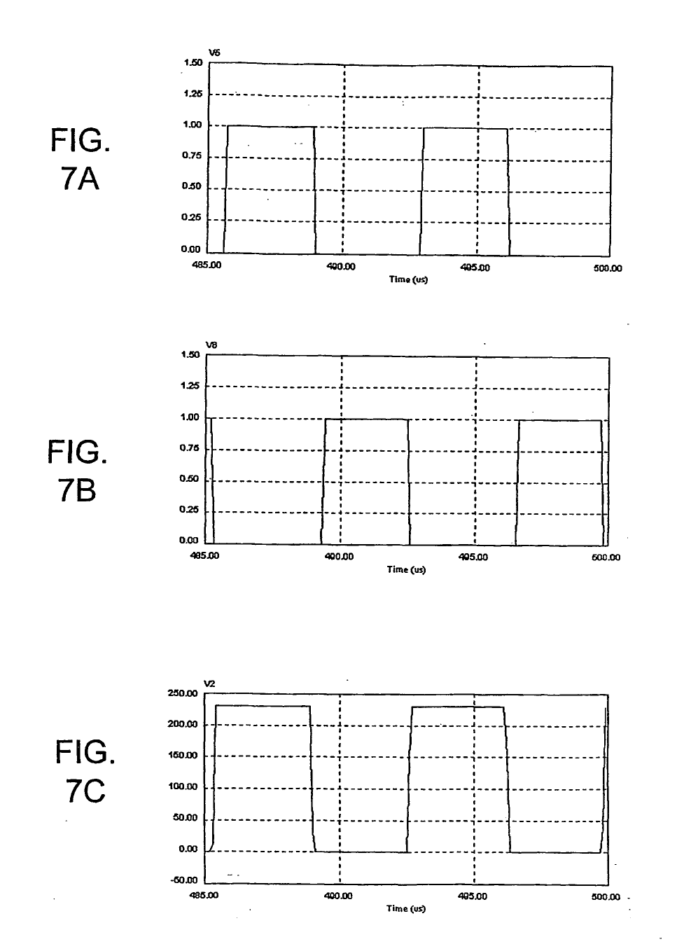

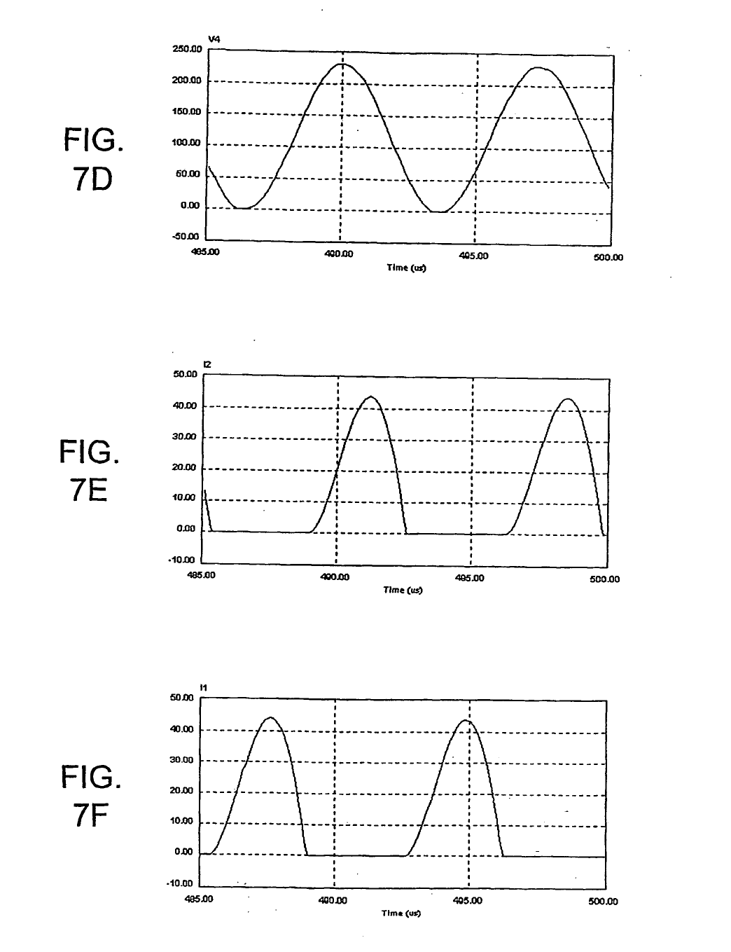

FIGS. 6A-6F illustrate simulated waveforms for a supply voltage of 380V, a 20% load, and a 220 kHz switching frequency. As shown, dead time between rise and fall of the currents 11, 12 remains negligible, even at this reduced loading. Examination of the simulated waveforms also shows that zero-voltage switching may be maintained for the transistors Q1, Q2 at this light load condition.

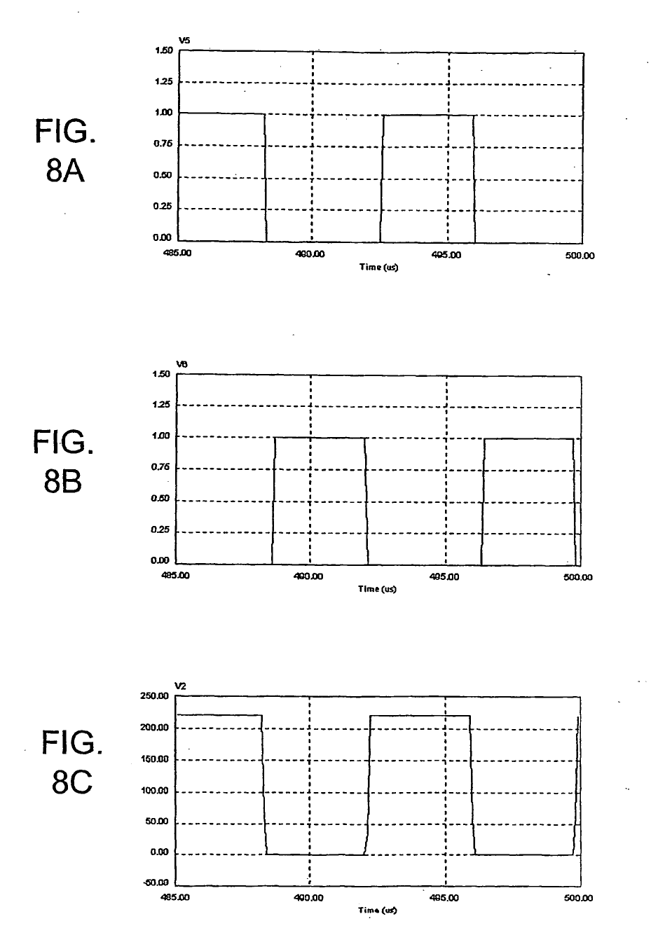

FIGS. 7A-7F illustrate simulated waveforms at a 230V supply voltage and an operating frequency of 140 KHz. The clamp diodes D1A, D1B now conduct for part of the cycle, modifying the resonant circuit to include the series inductance Lr and the capacitance C1 for the clamped portion of the waveform.

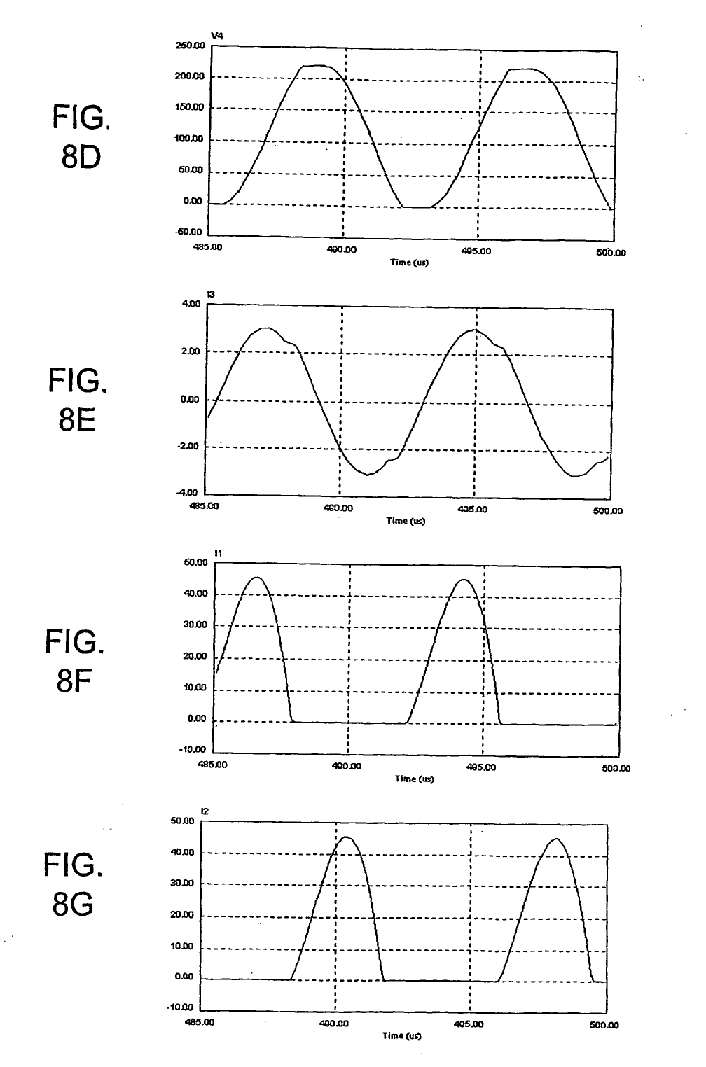

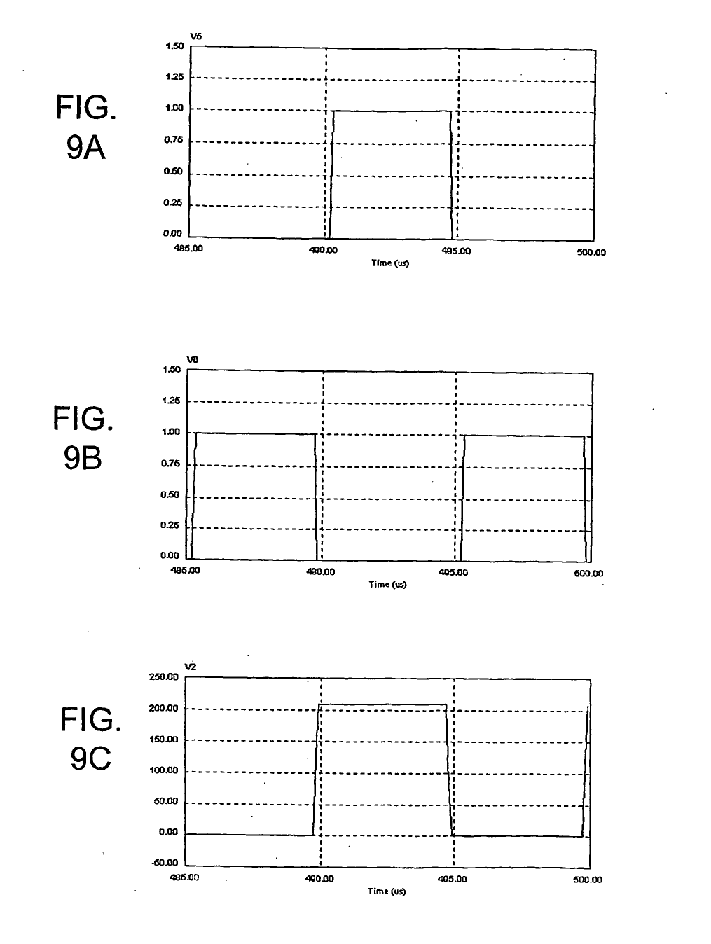

FIGS. 8A-8G illustrate simulated waveforms for an operating frequency of 130 KHz and a supply voltage of 220V. The clamp diodes D1A, D1B conduct for a significant period of time during each cycle, such that the converter operates in a resonant charge transfer mode wherein there is a period of time during each cycle when current is not flowing in either of the output diodes D2A, D2B. It may be preferable to avoid this operating mode in normal operation, but such operation may be acceptable during turn-off, when additional hold-up can be provided by allowing the converter to run down to lower supply voltages.

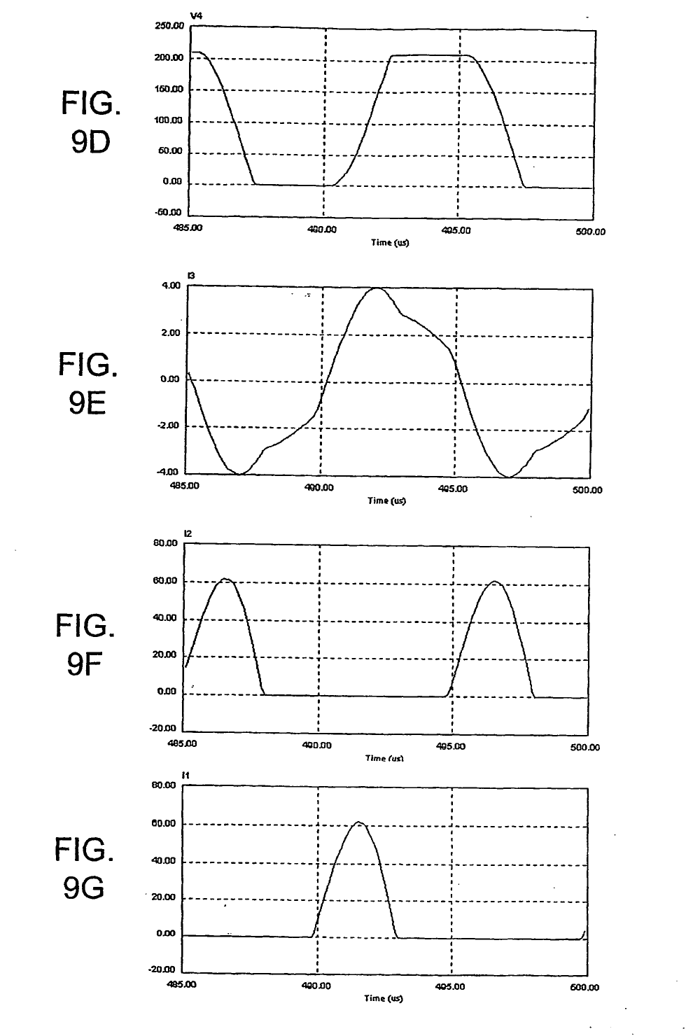

FIGS. 9A-9G show simulated waveforms at a supply voltage below that capable of providing a desired 5V output. The combination of a clamped resonant capacitors C2A, C2B and the resonant capacitor C1 allows the converter to operate at frequencies well below the desired minimum operating frequency while maintaining inductive loading to the transistors Q1, Q2, (i.e., turn-off with positive current flowing through the channel of the transistors Q1, Q2). In contrast, below-resonance operation of a conventional series resonant converter with a similar half-bridge input stage may be destructive, because the half-bridge transistors may operate with capacitive loading that can lead to high switching losses. Accordingly, conventional series resonant converters are often designed to operate with a minimum designed operating frequency that is 20-30% higher than the resonant frequency, which can lead to undesirably high circulating currents and undesirably low efficiency.

According to further embodiments of the invention, resonant components for a multi-resonant converter can be chosen as follows, with reference to the circuit designators of FIG. 2. The turns ratio of the transformer T and values of the inductors Lr, Lm may be chosen such that, at maximum switching frequency (when the impedances of C1 and C2A, C2B can be assumed to be small) and maximum supply voltage, the output voltage is below that desired for normal operation. The magnetizing inductance Lm may be chosen to be the same value as the series inductance Lr, which may be formed by the leakage inductance of the transformer T plus one or more additional external components. The turns ratio of the transformer T may be selected such that the reflected secondary voltage is greater than 25% of the highest anticipated supply voltage. The capacitor C1 may be chosen to be equal to the value of the capacitors C2A, C2B, which may be selected such that, at the minimum designed operating frequency, the effective impedance of Lr is reduced to 50%. This reduced effective inductance {jw(Lr)−1/jwC1) resonates with C2A, C2B. The resonant components Lr/2 and C2A, C2B may be chosen to provide sufficient current at a designated minimum operating supply voltage to provide a desired output power. At lower voltages and/or operating frequencies, the circuit may no longer provide the desired output power, but can operate safely in a resonant charge transfer mode, as discussed above.

FIG. 10 illustrates a converter apparatus 1000 according to still further embodiments of the invention. The apparatus 1000 includes an input circuit 1010, here shown as including a half-bridge circuit 1014 including first and second transistors Q1, Q2 controlled by a control circuit 1012. The converter apparatus 1000 further includes a multi-resonant circuit 1020 including a series combination of a capacitor C1, primary windings of first and second transformers T1, T2 and capacitors C2A, C2B. A clamping circuit 1030, including diodes D1A, D1B, is coupled to the multi-resonant circuit 1020. The apparatus 1000 further includes a self-driven synchronous rectifier circuit 1040 coupled to the secondary windings of the first and second transformers T1, T2. The rectifier circuit 1040 includes transistors Q3, Q4 coupled in a manner that provides complementary operation thereof, and a storage capacitor C3. The apparatus 1000 further includes an output filter circuit 1050 including an inductor Lout and a capacitor Cout.

The embodiments of FIG. 10 can provide several advantages, including improved manufacturability and reduced circulating energy. During a first half-period of the half-bridge, transformer T1 acts as a transformer and transformer T2 acts as a resonant inductor, and during a second half-period, the transformer T1 acts as a resonant inductor and transformer T2 acts as a transformer, giving substantially similar operation to that described above with reference to FIG. 2. However, during a switching instance of the transistors Q1, Q2, both secondary rectifiers become forward biased and current commutates from one secondary winding to the other under control of the leakage inductance of the transformers T1, T2. This can provide faster commutation and lower rms currents.

The use of two magnetic assemblies (transformers T1, T2) allows self-driven synchronous rectifiers to be used and can provide gate-drive to the rectifiers for substantially the entirety of each half-period of the converter. A potential drawback of the embodiments of FIG. 10 is that the short-circuit output currents may be higher and gate-drive to the synchronous rectifiers may be lost during short-circuit conditions. The output filter of the embodiments of FIG. 10 (C3, Lout, Cout) could also be applied to the other illustrated embodiments within the scope of the invention, which may provide lower output ripple voltage for a given cost than a circuit that just uses low impedance capacitors for output filtering. It will be appreciated that the self-driven rectifier circuit illustrated in FIG. 10 may also be replaced by a diode rectifier circuit within the scope of the invention.

Another potential advantage of the embodiments of FIG. 10 when used with synchronous rectifier output circuits is the ability to provide multiple outputs with good cross regulation, without requiring minimum loading on any particular output. This is can be achieved at relatively low cost by adding additional secondary windings with additional synchronous rectifier output circuits. Good cross regulation is known for series resonant topologies, but conventional circuits typically do not use self-driven synchronous rectifiers and, hence, may require minimum load on all outputs to obtain good cross regulation.

In the drawings and specification, there have been disclosed exemplary embodiments of the invention. Although specific terms are employed, they are used in a generic and descriptive sense only and not for purposes of limitation.

1. A power converter apparatus comprising a multi-resonant circuit comprising a series-resonant circuit and a frequency-dependent impedance connected in series with the series-resonant circuit and operative to counteract an inductance of the series-resonant circuit, a switching circuit operative to alternately apply first and second voltages to an input of the multi-resonant circuit, and a rectifier circuit coupled to an output of the multi-resonant circuit.

2. A power converter apparatus according to claim 1, wherein the frequency-dependent impedance decreases with an increase in frequency at which the first and second voltages are applied to the multi-resonant circuit.

3. A power converter apparatus according to claim 1, wherein the frequency-dependent impedance comprises a second series-resonant circuit.

4. A power converter apparatus, comprising:
a multi-resonant circuit comprising cascaded first and second series-resonant stages having respective first and second resonant frequencies;
a switching circuit operative to alternately apply first and second voltages to an input of the multi-resonant circuit; and
a rectifier circuit coupled to an output of the multi-resonant circuit.

5. An apparatus according to claim 4, wherein the first resonant frequency is less than the second resonant frequency.

6. An apparatus according to claim 5, wherein the first series-resonant stage is configured to allow the second series-resonant stage to operate at the second resonant frequency while maintaining inductive loading of the switching circuit.

7. An apparatus according to claim 4, further comprising a clamping circuit coupled to the multi-resonant circuit and operative to limit a voltage at the output of the multi-resonant circuit.

8. An apparatus according to claim 7, wherein the clamping circuit is configured to limit capacitive loading of the switching circuit by the second series-resonant stage.

9. An apparatus according to claim 4, or wherein the first and second resonant stages comprise respective series combinations of a capacitor and an inductor.

10. An apparatus according to claim 9, wherein the inductors of the first and second series-resonant stages comprise an inductance of a primary winding of a transformer, and wherein the rectifier circuit is coupled to a secondary winding of the transformer.

11. An apparatus according to claim 4, or wherein the first and second series-resonant stages comprise an inductance of primary winding of a transformer, and wherein the rectifier circuit is coupled to a secondary winding of the transformer.

12. An apparatus according to claim 1:
wherein the switching circuit is operative to alternately couple first and second terminals of a DC power source to an input of the multi-resonant circuit; and
wherein the multi-resonant circuit comprises:
a first capacitor having a first terminal coupled to the switching circuit;
an inductor having a first terminal coupled to a second terminal of the first capacitor; and
a second capacitor having a first terminal coupled to a second terminal of the inductor and a second terminal configured to be coupled to one of the first and second terminals of the DC power source.

13. An apparatus according to claim 12, wherein the second capacitor comprises two capacitors configured to be coupled between the second terminal of the inductor and respective ones of the first and second terminals of the DC power source.

14. An apparatus according to claim 1:
wherein the multi-resonant circuit comprises a series combination of a first capacitor, first and second primary windings of respective first and second transformers, and a second capacitor; and
wherein the rectifier circuit comprises a self-driven synchronous rectifier circuit coupled to first and second secondary windings of the first and second transformers.

15. An apparatus according to claim 1:
wherein the multi-resonant circuit comprises a series combination of a first capacitor, first and second primary windings of respective first and second transformers, and a second capacitor; and
wherein the rectifier circuit comprises a diode rectifier circuit coupled to first and second secondary windings of the first and second transformers.

16. An apparatus according to claim 1, wherein the switching circuit comprises a half-bridge circuit.

17. A power conversion method, comprising alternatively applying first and second voltages to an input of a multi-resonant circuit comprising a series-resonant circuit and a frequency-dependent impedance connected in series with the series-resonant circuit and operative to counteract an inductance of the series-resonant circuit; and responsively generating a DC voltage from a voltage at the output of the multi-resonant circuit.

18. A power conversion method according to claim 17, wherein the frequency-dependent impedance comprises a second series-resonant circuit.

19. A power conversion method according to claim 17, wherein the frequency-dependent impedance decreases with an increase in frequency at which the first and second voltages are applied to the multi-resonant circuit.

20. A power conversion method, comprising:
alternately applying first and second voltages to an input of a multi-resonant circuit comprising cascaded first and second series-resonant stages having respective first and second resonant frequencies; and
responsively generating a DC voltage from a voltage at an output of the multi-resonant circuit.

21. A method according to claim 20, wherein the first resonant frequency is less than the second resonant frequency.

22. A method according to claim 20, wherein the first and second resonant stages comprise respective series combinations of a capacitor and an inductor.

23. A method according to claim 22, wherein the inductors of the first and second resonant stages comprise a primary winding of a transformer, and wherein generating a DC voltage comprises generating the DC voltage from a voltage on a secondary winding of the transformer.

24. A method according to claim 20, wherein the multi-resonant circuit comprises:
a first capacitor having a first terminal coupled to the switching circuit;
an inductor having a first terminal coupled to a second terminal of the first capacitor; and
a second capacitor having a first terminal coupled to a second terminal of the inductor and a second terminal configured to be coupled to one of the first and second terminals of the DC power source.

25. A method according to claim 20:
wherein the multi-resonant circuit comprises a series combination of a first capacitor, first and second primary windings of first and second transformed and a second capacitor; and
wherein the generating a DC voltage comprises generating the DC voltage from a self-driven synchronous rectifier circuit coupled to first and second secondary windings of the first and second transformers.

26.-27. (canceled)
